(19) United States
(12) Patent Application Publication
(10) Pub. No.: US 2006/0098664 A1
(43) Pub. Date: May 11, 2006

(54) Intelligent application level multicast module for multimedia transmission

(75) Inventor: Luigi De Dona, Bologna (IT)

Correspondence Address: CARR & FERRELL LLP, 2200 GENG ROAD, PALO ALTO, CA, 94303, US

(73) Assignee: TVBLOB S.r.I.

(21) Appl. No.: 11/146,556

(22) Filed: Jun. 6, 2005

Related U.S. Application Data
(60) Provisional application No. 60/626,677, filed on Nov. 9, 2004.

(51) Int. Cl. H04L 12/56; H04L 12/28

(52) U.S. Cl. 370/401

(57) ABSTRACT

The application level multicast module can determine efficient routing configurations for the host node's transmission and reception of multimedia data from a network. Further, the application level multicast module may aggregate, buffer, process, and multimedia data to and from an application such as a multimedia player. The application level multicast module may base routing configuration determinations on many factors. For example, the application level multicast module may base a part of the routing configuration determination on the quality of a multimedia transmission, the performance of the host node, and/or the quality of the performance by other nodes receiving or forwarding multimedia data to the host node.

### CROSS-REFERENCE TO RELATED APPLICATIONS

This application claims priority from U.S. Provisional Patent Application No. 60/626,677 entitled “Systems and Methods for Audio Video Communication,” filed Nov. 9, 2004, the disclosure of which is incorporated herein by reference.

### BACKGROUND

1. Field of the Invention

The present invention relates generally to the transmission of multimedia data. More particularly, the present invention relates to systems and methods of an intelligent application level multicast module for multimedia transmission.

2. Background Art

As electronic communication and entertainment become more prevalent, multicasting is becoming ubiquitous. Multicasting is the concurrent distribution of multimedia data from one node to many nodes on a network. Multimedia data may be transmitted over the network to send videos, songs, sounds, animations, and images from one node to another. For example, multimedia data received by a node on the network may be a part of an event broadcast, videoconference, group collaboration, presentation, radio, news, sporting event, broadcasting, podcasting, flash animation, interactive game, commercial, and/or advertisement.

Multicasting has been implemented in several systems in the prior art, including Internet Protocol (IP) multicast, naive-multicast, and multicast over a content delivery network. Although multicasting is becoming more common, the systems in the prior art are limited in that they are not scalable, adaptive, self-organizing, robust, or cost-effective.

IP multicast has been implemented at the network level in Internet routers. However, IP multicast was not designed for large scale use and thus IP multicast has limited router scalability and a rigid structure. IP multicast also has security problems. Further, there is often a need for administrative servers to intervene regarding network routing decisions. Further, it is expensive and time consuming to supply software updates to all the routers in the Internet.

Naïve-multicast is one of the most common systems on the Internet. It creates a unicast connection for each receiver. However, the system is not scalable. To manage 1000 receivers for a single 1 Mb stream, a server-side connection of 1000 Mb is necessary. It is often necessary to maintain a cluster of servers which can send the data to all receivers. As a result, the streaming video found on the Internet today is often of poor quality.

Multicast over a content delivery network is a system that is at the application level or the network level. Multicast over a content delivery network is a network of servers placed at strategic points on the Internet which allows distribution of data. However, the system is very expensive and is limited in the number of users that can be supported.

Although application level multicast module systems have been used to transmit multimedia, the application level multicast module systems in the prior art have limited scalability. For example, application level multicast module systems in the prior art manage group membership through a central server which tracks every resource. The central server orders client positions within a spanning tree and manages every state for each node. As a result, the prior art lacks scalability and robustness. Further, this method suffers from slow response time.

### SUMMARY OF THE INVENTION

A system comprising a network interface configured to send and receive routing information from a first node on a network, a multimedia transmission router configured to send and receive multimedia data to a second node on the network, a transmission control layer module configured to process the multimedia data received from the multimedia transmission router and to ascertain a multimedia transmission quality metric, a host node manager configured to store host node information and to monitor host resource information, a quality manager configured to determine a multimedia metric limit based on the received from the transmission control layer module, and a topology manager configured to determine a routing configuration and generate a routing control signal based on the routing configuration determination.

The first node may comprise the second node. Further, the first node on the network may comprise a child client, a parent server, a parent server/child client, or an administrative server.

The routing configuration determination may be based on the host resource information received from the host node manager, the multimedia metric limit received from the quality manager, and/or the routing information received from the network interface. The routing information may comprise a node group ID, a host node ID, child node data, parent node data, and/or spare capacity group data.

The topology manager may be further configured to pass the routing control signal to the multimedia transmission router. Moreover, the transmission control layer module may be further configured to pass the routing control signal to the multimedia transmission router, send the processed multimedia data to a media player application, and/or receive the multimedia data from a broadcast application. The multimedia transmission router may send the multimedia data to a third node while the transmission control layer module sends the processed media data to the media player application. The third node may comprise the first node, the second node, or both.

A method comprising receiving at a first node routing information from a second node on a network, monitoring host resource information to improve routing performance, receiving at the first node multimedia data from a third node on the network, buffering the multimedia data, ascertaining a multimedia transmission quality metric, determining a multimedia metric limit based on the multimedia transmission quality metric to improve routing performance, determine a routing configuration based upon a routing characteristic, and generating a control signal based on the routing configuration determination.

A module comprising a module operational when executed by a processor to direct the processor to receive routing information from a first node on a network, receive multimedia data from a second node on the network, buffer the multimedia data, ascertaining a multimedia transmission quality metric, monitor host resource information, determine a multimedia metric limit based on the multimedia transmission quality metric, determine a routing configuration based on a routing characteristic, and generate a control signal based on the routing configuration determination, and a module storage medium operational to store the module.

### BRIEF DESCRIPTION OF THE DRAWINGS

FIG. 1 illustrates a network for multimedia transmission, in accordance with one embodiment;

FIG. 2 illustrates a block diagram of a digital device that may implement the application level multicast module, in accordance with one embodiment;

FIG. 3 illustrates a block diagram of an application level multicast module, in accordance with one embodiment;

FIG. 4 is a flowchart depicting a method for the application level multicast module as may be used for routing configuration determination for transmission of multimedia, in accordance with one embodiment; and

FIG. 5 is a flowchart depicting a method for the application level multicast module as may be used for broadcasting and measuring the quality of the multimedia transmission, in accordance with one embodiment.

### DETAILED DESCRIPTION OF THE EMBODIMENTS

Each node on a network may host an application level multicast module. The hosted application level multicast module can determine efficient routing configurations for the host node's transmission and reception of multimedia data from the network. Further, the application level multicast module may aggregate, buffer, process, and send multimedia data to and from an application such as a multimedia player.

The application level multicast module is “intelligent” in that it can determine routing configurations without requiring an external server on the network. The application level multicast module is “application level” in that it can provide support to applications and end-user processes. For example, the application level multicast module configures the host node to receive the transmission of multimedia data from one or more nodes on the network and then directs the multimedia data to the multimedia player application for the user.

In one embodiment, “application level” refers to the “application layer” which is the top layer in the Internet reference model. The application layer provides functions for users or their programs, and is highly specific to the performance of applications. The application layer provides the services that applications use to communicate over the network. Further, the application layer is the layer in which user-access network processes reside. The user-access network processes include all of those processes that users interact either directly and indirectly. Moreover, the application layer includes all applications protocols that use the host-to-host transport protocols to deliver data. Other functions that process user data, such as encryption, decryption, compression, and decompression can also reside at the application layer.

In this embodiment, the application layer manages interactivity between cooperating applications. For example, for cooperating applications to be able to exchange data, they must agree about how data is represented. The application layer may be responsible for standardizing the presentation of data.

The application level multicast module can base routing configuration determinations on one or more factors. For example, the application level multicast module may base a part of the routing configuration determination on the quality of a multimedia transmission, the performance of the host node, and/or the quality of the performance by other nodes receiving or forwarding multimedia data to the host node.

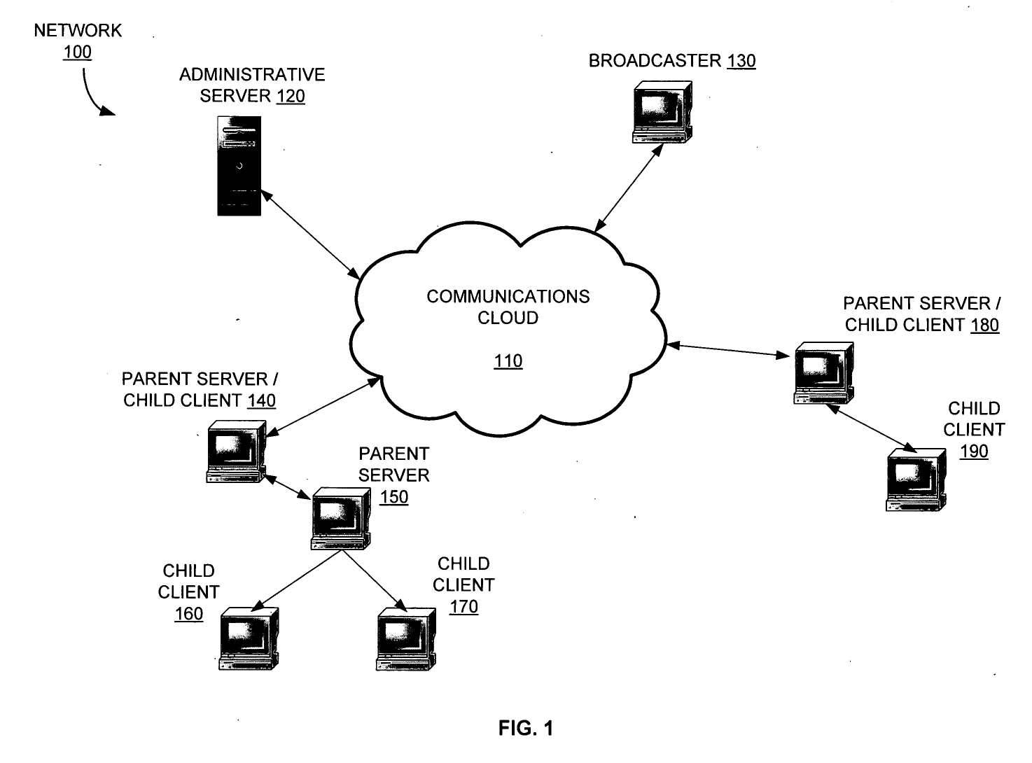

FIG. 1 illustrates a network 100 for multimedia transmission, in accordance with one embodiment. Nodes coupled to the communications cloud 110 include an administrative server 120, broadcaster 130, parent server/child client 140, parent server/child client 180, parent server 150, child client 160, child client 170, and child client 190. A node is a digital device that communicates with other nodes on the network 100.

The communications cloud 110 couples the nodes together to allow the nodes to communicate and transmit multimedia data to each other. The communications cloud 110 may be a single device or multiple devices. In one embodiment, the communications cloud 110 is a router that routes multimedia data to a limited number of nodes. In another embodiment, the communications cloud 110 comprises multiple routers, bridges, and hubs that couple a large number of nodes. A communications cloud 110 may also be another network, such as the Internet, that allows nodes to communicate and transmit multimedia data to each other.

Depending upon the topology of the network 100, the communications cloud 110 is optional. For example, the network 100 may connect the nodes with a ring topology. In a ring topology, each node may communicate directly to one or two nodes on the network 100 without the requirement of a communications cloud 110.

The broadcaster 130, parent server/child client 140, parent server/child client 180, parent server 150, child client 160, child client 170, and child client 190 may each comprise the application level multicast module. Each node on the network 100 may broadcast, receive, forward, and/or access multimedia data.

The broadcaster 130 broadcasts multimedia data to one or more nodes on the network 100. The broadcaster 130 may comprise a node with an application configured to allow a user of the broadcaster 130 to create original content, broadcast live multimedia data, or broadcast recorded content to the other nodes on the network 100.

The parent server 150 is a node that receives and forwards the multimedia data to one or more other nodes on the network 100. For example, the parent server 150 receives the multimedia data from the parent server/child client 140 and subsequently forwards the multimedia data to the child client 160 and the child client 170. The parent server 150 does not, however, access or play the multimedia data.

The child client 160, child client 170, and child client 190 are nodes that receive and access the multimedia from the network 100. For example, the child client 160, child client 170, and child client 190 may receive the multimedia data from the broadcaster 130 on the network 100. The child client 160, child client 170, and/or child client 190 may then access or play the multimedia data. For example, the child client 160 can buffer, process, and play the multimedia data with the multimedia player application. The child client 160, child client 170, and child client 190 do not forward the or broadcast multimedia data. Although the child client 160, child client 170, and child client 190 do not broadcast or forward the multimedia data, the child client 160, child client 170, and/or child client 190 may transmit routing information to other nodes of the network 100.

The parent server/child client 140 and the parent server/child client 180 are nodes which receive, forward, and access the multimedia data from the network 100. In an example, the parent server/child client 140 and the parent server/child client 180 receive the multimedia data from the broadcaster 130. Subsequently, the parent server/child client 140 and the parent server/child client 180 forward the multimedia data to another node on the network 100. The parent server/child client 140 and the parent server/child client 180 also access the multimedia data. For example, the parent server/child client 140 can buffer, process, and play the multimedia data with the multimedia player application. The parent server/child client 140 and the parent server/child client 180 may forward and access the multimedia data simultaneously.

An administrative server 120 is an optional node that may collect information regarding the network 100, the nodes, and/or the network routing. An example of the information regarding the network 100 may include throughput of data, efficiency of transmissions, transmission errors, data collision, lost packets, performance of individual nodes, and performance of groups of nodes. The broadcaster 130, parent server/child client 140, parent server/child client 180, parent server 150, child client 160, child client 170, and child client 190 may send information to the administrative server 120 regarding the quality of the multimedia transmission, host performance, the performance of surrounding nodes, subscription memberships, authorization requests, and/or accounting information. The administrative server 120 may also direct the nodes to conform to routing configurations.

The network 100 is a network for multimedia data transmission. The network 100 may comprise a local area network (LAN), a wide area network (WAN), Internet, intranet, extranet, Internet Protocol (IP) network, or any other network. The network 100 may be a smaller portion of a larger network. In another embodiment, the network 100 may comprise an overlay network. An overlay network is a virtual topology constructed on top of a network infrastructure. The concept of overlay networks enables multicast to be deployed as a service network rather than a network primitive mechanism, allowing deployment over heterogeneous networks without the need of universal network support. An example of an overlay network includes Pastry. Pastry is a network substrate that provides commands and services to nodes on a peer-to-peer network.

An example of the implementation of an overlay network with an application level multicast module for the transmission of multimedia data is a channel based broadcast subscribe system. The channel based broadcast subscribe system is a distributed system working over an IP network which allows the management of services (e.g. multimedia transmission and routing). The channel based broadcast subscribe system allows a user to subscribe to a particular channel on an IP network to receive a multimedia program or event.

A channel is the multimedia data transmitted by broadcaster 130. For example, in order for the child client 160 to receive the multimedia data broadcasted by the broadcaster 130, the child client 160 subscribes to the channel. Once the subscription has been authenticated and accepted by the administrative server 120, the child client 160 becomes a member of a multicast group and may receive the multimedia data.

A multicast group is a group of nodes which broadcast, receive, forward, and/or access the same multimedia data. When the parent server/child client 140, parent server/child client 180, parent server 150, child client 160, child client 170, or child client 190 receive the multimedia data from the broadcaster 130, they are a part of the same multicast group.

The overlay network may comprise one or more spanning trees comprising nodes that are associated by membership in the multicast group. A spanning tree is a network within the overlay network for the transmission of multimedia data from one or more broadcasters 130. The spanning tree may be the same size as the overlay network or smaller. In an example, the overlay network includes all of the nodes that make up the overlay network. The spanning tree includes all of the nodes that are members of a single multicast group. Each multicast group comprises a new spanning tree within the overlay network.

In one embodiment, the broadcaster 130 is the root of the spanning tree. The parent server/child client 140, parent server/child client 180, and the parent server 150 are branches within the spanning tree. The child client 160, child client 170, and child client 190 are leaves within the spanning tree.

The application level multicast module determines the routing configuration for each node within the spanning tree. The application level multicast module within each node will individually determine each node's routing configuration. For example, the user of the child node 160 may direct the application level multicast module to receive multimedia data from the broadcaster 130. Based on the available routing information (discussed further herein), the application level multicast module may generate a control signal to request the nearest parent server 150 or parent server/child client 140 to forward multimedia data.

The administrative server 120 within the channel based broadcast subscribe system may authenticate subscription requests from the nodes, collect accounting information, and direct the nodes to conform to routing configurations based on subscription requests. The child node 160 may request a subscription to a channel to receive multimedia data transmitted by broadcaster 130. The administrative server 120 receives and authenticates the subscription request. Subsequently, the administrative server 120 grants permission to the child node 160 to join the channel, receive, and then access the multimedia data broadcasted from the broadcaster 130.

In another embodiment, the administrative server 120 may be a ticket server which manages the purchasing and accounting of subscription requests. In an example, the user of child node 160 wishes to purchase a ticket from the administrative server 120 to subscribe to a particular channel. When the user purchases the ticket, the user provides personal information and a credit card number to the administrative server 120. The administrative server 120 authenticates the credit card and receives payment for the subscription request. Subsequently, the administrative server 120 issues confirmation to the user and a ticket to the child node 160 which allows the child node 160 to join the channel and receive the multimedia data from the broadcaster 130. In some embodiments, the administrative server 120 may charge different amounts to the user of child node 160 depending on the length of time the user wishes to receive the multimedia data.

The network 100 may also be a spare capacity group. A spare capacity group comprises one or more nodes which receive and forward multimedia data to other nodes within the multicast group. A single node may simultaneously be a member of the multicast group and the member of the spare capacity group.

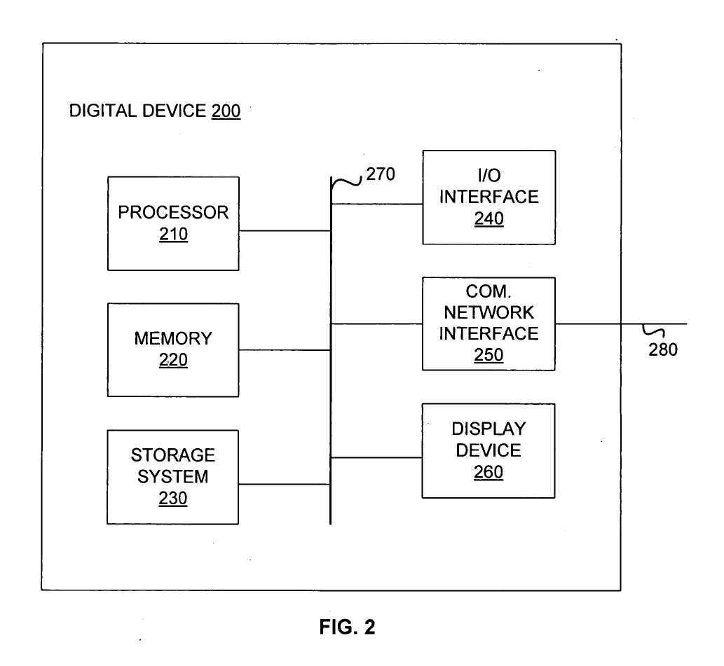

FIG. 2 illustrates a block diagram of a digital device 200 that may implement the application level multicast module, in accordance with one embodiment. The digital device 200 is any device that may implement either hardware, software, or both. Examples of digital devices 200 include, but are not limited to, computers, servers, terminals, personal digital assistants, cell phones, laptops, computing tablets, and personal media devices. The digital device may be a node on the network 100 including the administrative server 120, broadcaster 130, parent server/child client 140, parent server/child client 180, parent server 150, the child client 160, child client 170, or child client 190.

The digital device 200 includes a system bus 270 coupled to a processor 210, memory 220, storage system 230, input/output (I/O) interface 240, communications (com.) network interface 250, and a display device 260. The communications network interface 250 is further coupled to an external communications link 280.

The processor 210 is configured to execute software or instructions. The memory 220 is any memory device configured to hold data, either permanently or temporarily, to make the data available to any components connected to the system bus 270. The memory 220 may be configured to hold the application level multicast module.

The storage system 230 is any storage device or group of storage devices configured to store data permanently or temporarily. The storage system 230 may be configured to store the application level multicast module.

The I/O interface 240 is any interface or device configured to provide input or output to a user of the digital device 200. For example, the I/O-interface 240 may include a video interface, a remote control, a keypad, joystick, touch-screen, or buttons.

The communications network interface 250 is any communication interface configured to transfer data between any components connected to the system bus 270 and any communications network over the external communications link 280. The display device 260 is any device configured to visually interact with the user of the digital device 200. For example, the display device 260 may be a television screen, a monitor, a display for a cell phone, a display for a personal digital assistant, or a terminal display.

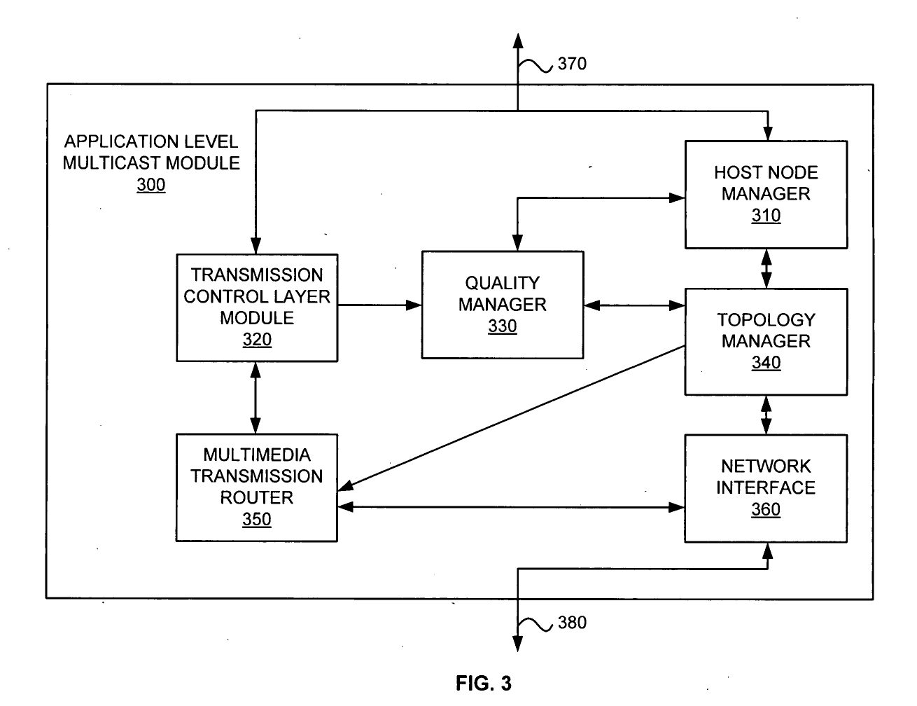

FIG. 3 illustrates a block diagram of an application level multicast module 300, in accordance with one embodiment. A host node (not depicted) may comprise the application level multicast module 300.

The application level multicast module 300 comprises a host node manager 310, a transmission control layer module 320, a quality manager 330, a topology manager 340, multimedia transmission router 350, and a network interface 360. The application level multicast module 300 is coupled to an application link 370 and a network link 380.

The host node manager 310 is coupled to the quality manager 330, the topology manager 340, and the application link 370. The host node manager 310 collects and stores host resource information of the host node. The host resource information comprises available bandwidth, available memory, CPU performance, user settings, shared host node resources, host node ID, node group ID, dependability level, and/or spare capacity group level.

The available bandwidth of the host node is the measure of the capacity of data that can be moved at one time from the host node to another node on the network. The available memory includes both the memory and the storage system of the host node available at one time. The CPU performance is an average performance of the node over a designated time. The CPU performance may comprise the quality of the processor, available memory, multimedia application speed, the quality of the transmission of the multimedia data received by the host node, the quality of the transmission of the multimedia data forwarded by the host node, and the speed at which the multimedia data may be forwarded, buffered, or processed.

The user settings may comprise bandwidth, memory, and/or available shared host resources allocated to the application level multicast module 300 by the user of the host node. Further, the user settings may comprise the multicast group membership of the host node, the dependability level, and/or the spare capacity group level. The user settings may be input by the user of the host node through a graphical user interface (GUI) (not depicted) or another application program that couples to the application level multicast module 300.

The shared node resources are those resources of the host node that may be shared with other nodes on the network. For example, if the host node is forwarding the multimedia data to another node on the network, the shared node resources would comprise that portion of the host node's bandwidth, memory, and CPU performance that are allocated to the task.

The host node ID identifies the host node. The host node ID may be unique and used to identify the host node on the network. The host node ID may comprise letters, numbers, or a combination of letters and numbers. In some embodiments, the user of the host node, the host node manager 310, the topology manager 340, or the administrative server assigns the host node ID to the host node.

The node group ID identifies the host node as a member of one or more multicast groups. For example, a user wishes to join a multicast group in order to receive a particular multimedia transmission. The user will subscribe to the multicast group. Subsequently, the host node manager 310 may either receive or generate the node group ID. The host resource information of the host node may further comprise multiple node group IDs. For example, a separate node group ID may be received or generated by the host node manager 310 for each multicast group of which the host node is a member.

The dependability level is a value that indicates the performance of the host node on the network over a designated time. In one embodiment, a high dependability level indicates that the host node's performance is very consistent. For example, a dependability level of “0” is the lowest level available and designates the host node as a guest member of the network. The dependability level of “0” may indicate that the host node is frequently shut down. A dependability level of“1”, “2”, “3”, or “4” designates the host node as a “member”, “gold member”, “super peer”, or a “multimedia root”, respectively. The dependability level of “4” may indicate that the host node is operating as a broadcaster. Further, the dependability level of “3” may indicate that the host node is operating at a high performance for a long period of time.

The dependability level may be assigned by the user of the host node or the administrative server. Further, the dependability level may be determined by the topology manager 340 based upon available host resources, the availability of shared node resources, and/or multimedia transmission quality metrics.

In one embodiment, the spare capacity group comprises one or more nodes of a multicast group that have available shared node resources to receive and forward multimedia data to one or more other nodes on the network. The spare capacity group level is a value that indicates the ability of the host node to allocate shared node resources to receive and forward multimedia data to other nodes on the network. For example, a spare capacity group level of“0” is the lowest level available and designates the host node as capable of sharing with other nodes of dependability level “0”. A spare capacity group level of “1” may indicate that the host node can share bandwidth resources with the nodes of dependability level “1” and “0”. A spare capacity group level of “2” may designate the host node as cable as sharing with nodes of dependability level “2”, “1”, and “0”. Further, a spare capacity group level of “3” may designate the host node as cable as sharing with nodes of dependability level “3”, “2”, “1”, and “0”.

In other embodiments, the host node may be a member of a spare capacity group that allows multimedia data to be forwarded to nodes in other multicast groups of which the host node is not a member. The spare capacity group level may be assigned by the user of the host node or the administrative server. Further, the spare capacity group level may be determined by the topology manager 340 based upon the available host resources, the availability of shared node resources, and/or multimedia transmission quality metrics.

The transmission control layer module 320 is coupled to the quality manager 330, the multimedia transmission router 350, and the application link 370. The transmission control layer module 320 aggregates, buffers, and/or processes the multimedia data received from the multimedia transmission router 350. Subsequently, the transmission control layer module 320 may send the multimedia data to the application link 370 which may be further coupled to the multimedia player application, multimedia broadcast application, or any application that controls, manipulates, edits, or plays the multimedia data. The transmission control layer module 320 also ascertains a multimedia transmission quality metric and sends the multimedia transmission quality metric to the quality manager 330.

The multimedia transmission quality metric is a measurement of the transmission of the multimedia data received by the host node. The multimedia transmission quality metric may comprise a response time metric, a packet loss metric, a packet delay metric, and/or a node stress metric. The response time metric is the time taken to receive an initial packet of data. The packet loss metric is the number of packets of data lost during a given allotment of time. The packet delay metric is the average time between packets of data. The node stress metric is determined by measuring the quantity and the distribution of the nodes receiving multimedia data from the host node. The multimedia transmission quality metric may comprise any number of measurements that collect information regarding multimedia transmission, communications, or routing.

In another embodiment, the transmission control layer module 320 aggregates, buffers, and/or processes the multimedia data received from the application over the application link 370. Subsequently, the transmission control layer module 320 sends the multimedia data to the multimedia transmission router 350 to transmit the multimedia data to one or more other nodes on the network.

The quality manager 330 is coupled to the host node manager 310, the transmission control layer module 320, and the topology manager 340. The quality manager 330 monitors the quality of multimedia data transmission, evaluates performance of the host node, and recommends actions to the topology manager 340.

In one embodiment, the quality manager 330 receives and evaluates the multimedia transmission quality metric from the transmission control layer module 320 to determine a multimedia metric limit. The multimedia metric limit is an evaluation of the quality of the multimedia data transmission based on the multimedia transmission quality metric. The quality manager 330 then makes recommendations based on the multimedia metric limit and sends the recommendations to the topology manager 340. In another embodiment, the quality manager 330 may send the multimedia metric limit to the topology manager 340.

For example, the quality manager 330 may receive the multimedia transmission quality metric from the transmission control layer module 320. When the transmission control layer module 320 ascertains the multimedia transmission quality metric, data is merely collected but not analyzed. The quality manager 330 analyzes the multimedia transmission quality metric to determine the multimedia metric limit. The quality manager 330 may then make a recommendation and send the recommendation to the topology manager 340.

In another example, the number of packets of data lost (packet loss) during reception of a multimedia transmission within a given time may be sent from the transmission control layer module 320 to the quality manager 330 as the multimedia transmission quality metric. The quality manager 330 receives the multimedia transmission quality metric and determines a multimedia metric limit that indicates that the packet loss is too high. The quality manager 330 may form a recommendation that the host node should receive the multimedia data transmission from another node on the network. Subsequently, the quality manager 330 sends the recommendation to the topology manager 340.

In another embodiment, the quality manager 330 evaluates performance of the host node. The quality manager 330 may receive and evaluate host resource information from the host node manager 310. The host resource information may indicate the performance of the host node. The quality manager 330 may then make recommendations and send the recommendations to the topology manager 340. For example, the quality manager 330 receives the host resource information from the host node manager 310. Based on the host resource information, the quality manager 330 determines that the available resources of the host node are too low. Subsequently, the quality manager 330 sends a recommendation to the topology manager 340 that the host node should not forward multimedia transmissions to other nodes on the network.

The topology manager 340 is coupled to the host node manager 310, the quality manager 330, the multimedia transmission router 350, and the network interface 360. The topology manager 340 manages the application level multicast module 300.

The topology manager 340 receives and stores the child node data, the parent node data, and the spare capacity group data. The child node data is the information associated with the nodes that receive the forwarded multimedia data from the host node. The parent node data is the information associated with the nodes that transmit and/or broadcast the multimedia data to the host node. The spare capacity group data is the routing information associated with the nodes that are members of a spare capacity group available to the host node. The topology manager 340 may receive the child node data, the parent node data, and the spare capacity group data from one or more node on the network or an administrative server. Further, the topology manager 340 may generate the child node data, the parent node data, and the spare capacity group data based on the routing information (discussed herein) received from the network interface 360.

The topology manager 340 may receive the host resource information from the host node manager 310, the multimedia metric limit from the quality manager 330, and routing information from the network interface 360. The topology manager 340 may determine a routing characteristic based on the host resource information, the multimedia metric limit, or the routing information. Subsequently, the topology manager 340 determines a routing configuration based on the routing characteristic. The topology manager 340 then generates a control signal based on the routing characteristic.

In one example, the topology manager 340 receives host resource information from the host node manager 310 indicating that the available bandwidth is very limited. The child node data indicates that the host node is forwarding multimedia data to a first node and a second node on an overlay network. Based on this information, the topology manager 340 determines the routing characteristic that indicates that the multimedia data will be forwarded only to the first node. The routing configuration is determined based on the routing characteristic. The topology manager 340 then generates the control signal based on the routing configuration and transmits the control signal to the network interface 360. The network interface 360 receives the control signal and generates the commands for the overlay network. The commands are then transmitted to notify the second node that it will no longer be receiving the multimedia data from the host node. The topology manager 340 will then notify the multimedia transmission router 350 to forward multimedia data to only the first node.

The multimedia transmission router 350 is coupled to the transmission control layer module 320, the topology manager 340, and the network interface 360. In one embodiment, the multimedia transmission router 350 receives multimedia data from one or more other nodes on the network over the network interface 360. Subsequently, the multimedia transmission router 350 may forward the multimedia data to one or more nodes on the network identified by the topology manager 340. The multimedia transmission router 350 may also send or receive the multimedia data to the transmission control layer module 320. In another embodiment, the multimedia transmission router 350 receives the multimedia data from the transmission control layer module 320. Subsequently, the multimedia transmission router 350 transmits the multimedia data to one or more other nodes on the network identified by the topology manager 340.

The network interface 360 is coupled to the topology manager 340, the multimedia transmission router 350, and the network link 380. The network interface 360 is any network interface configured to transfer data between the application level multicast module 300 and any communications network over the network link 380. In another embodiment, the network interface 360 is any network interface configured to transfer data received from any communications network to the host node.

The network interface 360 may comprise an interface to communicate with an overlay network. Further, the network interface 360 may comprise a library of routing commands for communicating routing commands with nodes over the overlay network. For example, routing commands may be received by the network interface 360 from other nodes on the overlay network. The network interface 360 translates the routing commands and sends the routing commands to the topology manager 340 as routing information. The topology manager 340 may evaluate the routing commands and determine a routing characteristic based on the routing information. In another example, the topology manager 340 may send routing commands to the network interface 360. The network interface 360 then translates the routing commands using the library of routing commands to transmit the routing commands to other nodes on the overlay network.

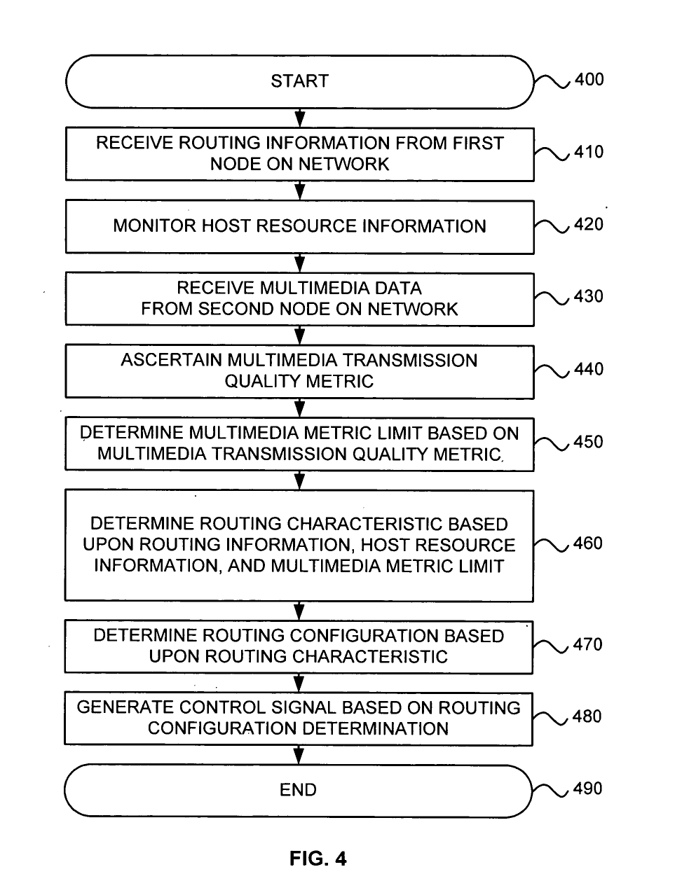

FIG. 4 is a flowchart depicting a method for the application level multicast module 300 as may be used for routing configuration determination for transmission of multimedia, in accordance with one embodiment. FIG. 4 begins in step 400. In step 410, the application level multicast module 300 receives routing information from a first node on the network. The routing information may comprise a node group ID of the first node, a node ID of the first node, child node data, parent node data, and/or spare capacity group data. In one example, the network interface 360 receives routing information from over the network link 380. The network interface 360 translates the routing information and then sends the routing information to the topology manager 340. The first node may be a broadcaster, parent server, or parent server/child client.

In step 420, the application level multicast module 300 monitors the host resource information. For example, the host node manager 310 may monitor the bandwidth, available memory, CPU performance, user settings, shared host node resources, node ID, node group ID, dependability level, and spare capacity group level. In step 430, the application level multicast module 300 receives multimedia data from a second node on the network. For example, the multimedia data may be transmitted from the second node on the network to the host node. Subsequently, the network interface 360 receives the multimedia data over the network link 380. The network interface 360 may then send the multimedia data to the multimedia transmission router 350. The multimedia transmission router 350 will then send the multimedia data to the transmission control layer module 320. The first node and the second node may comprise the same node.

In step 440, the application level multicast module 300 ascertains the multimedia transmission quality metric by monitoring the transmission of the multimedia data. For example, transmission control layer module 320 may monitor the transmission of the multimedia data to ascertain the multimedia transmission quality metric. The multimedia transmission quality metric may comprise the response time metric, the packet loss metric, the packet delay metric, the link stress metric, and the node stress metric. The transmission control layer module 320 then sends the multimedia transmission quality metric to the quality manager 330.

In step 450, the application level multicast module 300 determines the multimedia metric limit based on the multimedia transmission quality metric. For example, the quality manager 330 may determine the multimedia metric limit based upon the multimedia transmission quality metric received from the transmission control layer module 320. The quality manager 330 may then send the multimedia metric limit to the topology manager 340.

In step 460, the application level multicast module 300 determines the routing characteristic based on the routing information, host resource information, and/or the multimedia metric limit. For example, the topology manager 340 may receive routing information from other nodes on the network and host resource information from the host node manager 310. Further, the topology manager 340 may receive the multimedia metric limit from the quality manager 330. Based on the routing information, host resource information, and the multimedia metric limit, the topology manager 340 determines the routing characteristic.

In step 470, the application level multicast module 300 determines the routing configuration based on the routing characteristic. For example, the topology manager 340 may determine the routing configuration based on the previously determined routing characteristic.

In step 480, the application level multicast module 300 generates the control signal based on the routing configuration determination. For example, the routing characteristic determined by the topology manager 340 may comprise the multimedia metric limit that indicates that packet loss is too high and routing information that indicates that a parent node identified by the parent node data is no longer sending data. The topology manager 340 then determines the routing configuration based on the routing characteristic to request that a new parent server node transmit multimedia data to the host node and generates the control signal to implement the request. In another embodiment, the host node may be receiving multimedia data from multiple parent servers and the application level multicast module 300 may generate a control signal to request one or more additional parent servers.

The control signal may be sent from the topology manager 310 to the multimedia transmission router 350, the network interface 360, or other nodes on the network. In one embodiment, the control signal may be sent from the topology manager 310 to the transmission router 350 to command the transmission router 350 to transmit multimedia data to specific nodes on the network. In another example, the control signal may be sent to the transmission router 350 to terminate the transmission of multimedia data to one or more nodes on the network. In another embodiment, the topology manager 310 sends the control signal to the network interface 360 to command the network interface 360 to send commands to nodes on the overlay network. In yet another embodiment, the topology manager 310 transmits the control signal directly to one or more other nodes on the network to indicate routing decisions.

In another example, the user may no longer desire a particular transmission of multimedia data. The user may command the multimedia player application to terminate reception of multimedia data. The request to terminate reception of the multimedia data is received, stored, and sent by the host node manager 310 to the topology manager 340 as host resource information. As a result, the topology manager 340 determines the routing characteristic to communicate with one or more parent servers currently forwarding multimedia data to the host node. The topology manager 340 determines the routing configuration based on the routing characteristic and then generates a control signal which is received by the network interface 360. The network interface 360 may then translate the command and send the translation to the one or more parent servers requesting that they terminate forwarding of the multimedia data to the host node. The topology manager 340 may also generate a control signal to request that one or more child clients receive multimedia data from another node. Moreover, the topology manager 340 may also generate a control signal to indicate that the multimedia transmission router 350 cease receiving multimedia data. FIG. 4 ends in step 490.

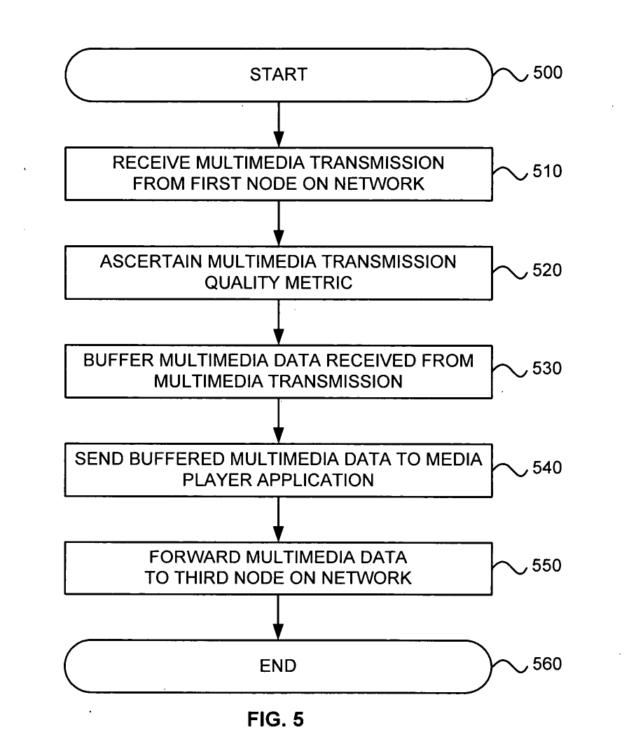

FIG. 5 is a flowchart depicting a method for the application level multicast module 300 as may be used for broadcasting and measuring the quality of the multimedia transmission, in accordance with one embodiment. FIG. 5 begins in step 500. In step 510, the application level multicast module 300 receives multimedia data from the first node on the network. For example, the network interface 360 receives multimedia data from the first node and sends the multimedia data to the multimedia transmission router 350. The multimedia transmission router 350 then sends the multimedia data to the transmission control layer module 320.

In step 520, the application level multicast module 300 ascertains the multimedia transmission quality metric. For example, the transmission control layer module 320 ascertains the multimedia transmission quality metric by monitoring the transmission of the multimedia data and then sends the multimedia transmission quality metric to the quality manager 330. In step 530, the application level multicast module 300 buffers the multimedia data. For example, the transmission control layer module 320 buffers the multimedia data.

In step 540, the application level multicast module 300 sends the buffered multimedia data to the multimedia player application. In one embodiment, the transmission control layer module 320 sends the buffered multimedia data to the application link 370 which is coupled to the multimedia player application.

In step 550, the application level multicast module 300 forwards the multimedia data to a third node on the network. For example, the multimedia transmission router 350 may forward the multimedia data through the network interface 360. The third node may be identified by the topology manager 340 which controls where the multimedia transmission router 350 transmits the multimedia data. FIG. 5 ends in step 560.

In some embodiments, the application level multicast module 300 is a true peer-to-peer system wherein the software processes of routing and multimedia is run on the nodes and not on a centralized server. With the application level multicast module 300, each node can be either a broadcaster that broadcasts multimedia data, a parent server/child client that receives and forwards the multimedia data, a parent server that forwards the multimedia data, and/or a child client that receive the multimedia data. Further, each node may be a member of two or more multicast groups. For example, in one multicast group, a node can be a broadcaster. In a second multicast group, the same node may be a child client.

The embodiments discussed herein are illustrative of the present invention. As these embodiments of the present invention are described with reference to illustrations, various modifications or adaptations of the methods and/or specific structures described may become apparent to those skilled in the art. All such modifications, adaptations, or variations that rely upon the teachings of the present invention, and through which these teachings have advanced the art, are considered to be within the spirit and scope of the present invention. Hence, these descriptions and drawings should not be considered in a limiting sense, as it is understood that the present invention is in no way limited to only the embodiments illustrated.

What is claimed is:

1. A system comprising:
a network interface configured to send and receive routing information from a first node on a network;
a multimedia transmission router configured to send and receive multimedia data from a second node on the network;
a transmission control layer module configured to process the multimedia data received from the multimedia transmission router and to ascertain a multimedia transmission quality metric;
a host node manager configured to store host node information and to monitor host resource information;
a quality manager configured to determine a multimedia metric limit based on the multimedia transmission quality metric received from the transmission control layer module; and
a topology manager configured to determine a routing configuration and generate a routing control signal based on the routing configuration determination.

2. The system of claim 1 wherein the first node comprises the second node.

3. The system of claim 1 wherein the routing configuration determination is based on the host resource information received from the host node manager.

4. The system of claim 1 wherein the routing configuration determination is based on the multimedia metric limit received from the quality manager.

5. The system of claim 1 wherein the routing configuration determination is based on the routing information received from the network interface.

6. The system of claim 1 wherein the routing information comprises a node group ID, a host node ID, child node data, parent node data, and/or spare capacity group data.

7. The system of claim 1 wherein the first node on the network comprises a child client, a parent server, a parent server/child client, or an administrative server.

8. The system of claim 1 wherein the topology manager is further configured to pass the routing control signal to the multimedia transmission router.

9. The system of claim 1 wherein the transmission control layer module is further configured to send the processed multimedia data to a media player application.

10. The system of claim 9 wherein the multimedia transmission router sends the multimedia data to a third node while the transmission control layer module sends the processed media data to the media player application.

11. The system of claim 10 wherein the third node comprises the first node, the second node, or both.

12. The system of claim 1 wherein the transmission control layer module is further configured to receive the multimedia data from a broadcast application.

13. A method comprising:
receiving at a first node routing information from a second node on a network;
monitoring host resource information to improve routing performance;
receiving at the first node multimedia data from a third node on the network;
buffering the multimedia data;
ascertaining a multimedia transmission quality metric;
determining a multimedia metric limit based on the multimedia transmission quality metric to improve routing performance;
determine a routing configuration based upon a routing characteristic; and
generating a control signal based on the routing configuration determination.

14. The method of claim 13 wherein the second node comprises the third node.

15. The method of claim 13 wherein the routing characteristic comprises the host resource information, the multimedia metric limit, and/or the routing information or a combination thereof.

16. The method of claim 13 wherein the routing information comprises a node group ID, a host node ID, child node data, parent node data, and/or spare capacity group data.

17. The method of claim 13 wherein the second node on the network comprises a child client, a parent server, a parent server/child client, or an administrative server.

18. The method of claim 13 further comprising sending multimedia data to a fourth node on the network.

19. The method of claim 18 wherein the fourth node comprises the second node.

20. The method of claim 18 wherein the multimedia data is sent to the fourth node on the network while the multimedia data is buffered.

21. The method of claim 13 further comprising passing the routing control signal to a multimedia transmission router.

22. The method of claim 13 further comprising sending the buffered multimedia data to a media player application.

23. The method of claim 13 further comprising receiving the multimedia data from a broadcast application.

24. A module comprising:
a module operational when executed by a processor to direct the processor to receive routing information from a first node on a network, receive multimedia data from a second node on the network, buffer the multimedia data, ascertaining a multimedia transmission quality metric, monitor host resource information, determine a multimedia metric limit based on the multimedia transmission quality metric, determine a routing configuration based on a routing characteristic, and generate a control signal based on the routing configuration determination; and
a module storage medium operational to store the module.

25. The module of claim 24 wherein the first node comprises the second node.

26. The module of claim 24 wherein the module is operational when executed by the processor to send the multimedia data to a third node on the network.

27. The module of claim 26 wherein the module is operational when executed by the processor to send the multimedia data to the third node on the network while the multimedia data is buffered.

28. The module of claim 27 wherein the third node comprises the first node.

29. The module of claim 24 wherein the routing characteristic comprises the host resource information, the multimedia metric limit, or the routing information or a combination thereof.
